(19) United States
(12) Patent Application Publication
(10) Pub. No.: US 2009/0016580 A1
(43) Pub. Date: Jan. 15, 2009

(54) BREAST IMAGE PROCESSING SYSTEM AND BREAST IMAGE PROCESSING METHOD

(75) Inventors: Youji Yamamichi, Tokyo (JP); Mamoru Umeki, Tokyo (JP); Eiichi Akagi, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/909,309

(22) PCT Filed: Dec. 21, 2005
(86) PCT No.: PCT/JP2005/023458

§ 371 Date: Sep. 21, 2007

(30) Foreign Application Priority Data
Mar. 23, 2005 (JP) 2005-084107

(51) Int. Cl. G06K 9/54

(52) U.S. Cl. 382/128

(57) ABSTRACT

The problems that a skipping area is shown in the chest wall portion of the output image and image information on the chest wall portion lacks when the left and right breast images are recorded on films and outputted to compare and examine the images on the film viewer are solved. An image processing device of a breast image processing system performs a format processing so that the chest wall portions of left and right breast images created by an image creating device may be disposed on the writing commencement position H sides of an image recording apparatus.

### FIELD OF THE INVENTION

The present invention relates to a breast image processing system and a breast image processing method, in which a format processing is applied to left and right breast image data, so that each of the left and right breast images is individually formed on each of recording mediums to be outputted, based on the processed image data.

### TECHNICAL BACKGROUND

Conventionally, medical images have been displayed on a monitor, such as a CRT (Cathode Ray Tube), etc., based on processed image data acquired by applying various kinds of image processing, including a gradation processing, etc., to digital image data, which represent medical images and which are inputted from various kinds of modalities, such as a CT (Computed Tomography), a MRI (Magnetic Resonance Imaging), a CR (Computed Radiography), a FPD (Flat Panel Detector), an ultrasonic diagnostic equipment, etc., so that the doctor can observe the medical images displayed on the monitor for medical inspection. Alternatively, based on the processed image data acquired by applying various kinds of image processing, the medical images have been recorded on the recording mediums, such as a film, etc., to be outputted as hardcopies, so that the doctor can observe the medical images by putting them on the film viewer for medical inspection.

When the doctor observes medical images of the breast (namely, mammography) for making diagnosis, the doctor have been liable to conduct the comparing film-image observation in which the left and right breast film images are compared with each other while placing the left and right breast film images side by side on the film viewer. In other words, when the doctor conducts the comparing film-image observation of the left and right breast images outputted as the hardcopies, the doctor loads them side by side on the film viewer in such a manner that the chest wall edges of them matches with each other. In order to makes the comparing film-image observation, to be conducted on the film viewer, easy, for instance, Patent Document 1 sets forth a technology for adjusting the positions of them so that the chest wall portions of left and right breast images are outputted at side edges of the films.

In this connection, when the breast images are recorded by an image recording apparatus employing a laser recording method, the image recording apparatus conducts the position regulating operation for making the exposure-scanning commencement position coincide with the edge of the film by correcting the position of the film conveyed, before writing the image onto the film, as set forth in Patent Document 2.

[Patent Document 1]
Tokkai 2002-158853, (Japanese Non-Examined Patent Publication)

[Patent Document 2]
Tokkaihei 8-133529, (Japanese Non-Examined Patent Publication)

### DISCLOSURE OF THE INVENTION

### Subject to be Solved by the Invention

However, since the allowance of +1 mm for the film size is specified in the JIS (Japanese Industrial Standard), for instance, when the relationship between the exposure-scanning commencement position (writing commencement position) H and the reproduced image is indicated by the diagram shown in FIG. 18(a), namely, when the film size is larger than the image size represented by the image data due to the “+” error of the film size, sometimes, a skipping area (transparent area) at which no laser beam is exposed would be created at the chest wall portion. When the observer employs the film viewer (light box) to observe such the breast image on the film, since the light irradiated from the light source of the film viewer fiercely passes through the abovementioned transparent area and dazzles the eyes of observer, the observer hardly observes the chest wall portion, and accordingly, such the breast image with the transparent area is not preferable for the viewer. Further, when the film size is smaller than the image size represented by the image data due to the “−” error of the film size as shown in FIG. 18(b), there would arise another problem that image information of the chest wall portion, being important for the diagnosis, would drop out. Still further, even when some deviation is created between them as a result of the position regulating operation, the abovementioned defects, such as the generation of the skipping area (transparent area), the lack of image information of the chest wall portion, etc., would occur.

### SUMMARY OF THE INVENTION

To overcome the abovementioned drawbacks in conventional breast image processing system, it is one of objects of the present invention to prevent the occurrences of the defects, such as the generation of the skipping area (transparent area), the lack of image information of the chest wall portion, etc., when the left and right breast images are individually recorded on the film to be outputted for conducting the comparing film-image observation of the left and right breast images on the film viewer.

Accordingly, at least one of the objects of the present invention can be attained by the breast image processing systems described as follows.

(1) According to a breast image processing system reflecting an aspect of the present invention, the breast image processing system, comprises: an image data creating apparatus that separately radiographs a left breast and a right breast, both of which belong to a same patient, so as to create left breast image data and right breast image data; a processing apparatus that is provided with a format processing section to apply a format processing to each of the left breast image data and the right breast image data, both created by the image data creating apparatus; and an image recording apparatus that records and outputs a left breast image and a right breast image onto a recording medium, based on the left breast image data and the right breast image data to each of which the format processing is applied by the processing apparatus; wherein the format processing section applies the format processing to each of the left breast image data and the right breast image data in such a manner that each of a chest wall portion of the left breast image and another chest wall portion of the right breast image is placed at a position, which has a predetermined relationship with a writing commencement position in the image recording apparatus.
(2) According to another aspect of the present invention, in the breast image processing system recited in item 1, the processing apparatus is further provided with a position adjusting section that adjusts a position of at least one of the left breast image and the right breast image, when the left breast image and the right breast image are aligned in a left-right direction in such a manner that a chest wall side of the left breast image and another chest wall side of the right breast image match with each other, so that positions of left and right breasts in the left breast image and the right breast image in an upper-lower direction substantially coincide with each other, and then, applies the format processing to each of the left breast image data and the right breast image data.
(3) According to still another aspect of the present invention, in the breast image processing system recited in item 1, the processing apparatus is further provided with an acquiring section to acquire information with respect to an alignment of the recording medium onto which an image is written in the image recording apparatus: and

wherein the format processing section applies the format processing to each of the left breast image data and the right breast image data, based on the information acquired by the acquiring section.

(4) According to still another aspect of the present invention, the breast image processing system recited in item 1, further comprises: a communication network through which the image data creating apparatus, the processing apparatus and the image recording apparatus are coupled to each other.
(5) According to still another aspect of the present invention, in the breast image processing system recited in item 4, a plurality of image recording apparatuses are coupled to the communication network; and the acquiring section acquires the information, with respect to the alignment of the recording medium, onto which an image is written in the image recording apparatus, from each of the plurality of image recording apparatuses; and the format processing section applies the format processing to each of the left breast image data and the right breast image data, based on the acquired information corresponding to the image recording apparatus to be an output destination of each of the left breast image and the right breast image.
(6) According to still another aspect of the present invention, in the breast image processing system recited in item 1, the image recording apparatus is provided with: a conveyance section to convey the recording medium one by one; an exposure scanning section to form an image onto the recording medium by conducting an exposure/scanning operation for the recording medium conveyed by the conveyance section; and a position regulating section to conduct a position regulating operation, so that one side of the recording medium coincides with an exposure/scanning commencement position of the exposure/scanning operation to be conducted by the exposure scanning section; and the format processing section applies the format processing, so that each of the chest wall portion of the left breast image and the other chest wall portion of the right breast image is placed at one side, the position of which is regulated by the position regulating section.
(7) According to still another aspect of the present invention, in the breast image processing system recited in item 1, the image recording apparatus is provided with: a conveyance section to convey the recording medium one by one; an exposure scanning section to form an image onto the recording medium by conducting an exposure/scanning operation for the recording medium conveyed by the conveyance section; and a write control section to control a write commencement timing when forming an image from a leading edge side in a conveyance direction of the recording medium; and the format processing section applies the format processing, so that each of the chest wall portion of the left breast image and the other chest wall portion of the right breast image is placed at the leading edge side in the conveyance direction of the recording medium.
(8) According to still another aspect of the present invention, in the breast image processing system recited in item 1, the image recording apparatus is provided with: a conveyance section to convey the recording medium one by one; an exposure scanning section to form an image onto the recording medium by conducting an exposure/scanning operation for the recording medium conveyed by the conveyance section; and a write control section to control a write commencement timing when forming an image from a leading edge side in a conveyance direction of the recording medium, so as to create a non-exposure area at a leading edge portion; and the format processing section applies the format processing, so that each of the chest wall portion of the left breast image and the other chest wall portion of the right breast image is placed at a position being apart from the leading edge side by a predetermined distance in the conveyance direction of the recording medium.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a conceptual block diagram indicating an overall configuration of a breast image processing system 100 embodied in the present invention;

FIG. 2 shows a block diagram of a functional configuration of an image processing apparatus 2;

FIG. 3 shows a block diagram of a functional configuration of an image recording apparatus 3;

FIG. 4 shows a perspective view indicating a brief structure of a film conveyance section 37 and a position regulating section 38 shown in FIG. 3;

FIG. 5 shows a schematic diagram indicating a position regulating method in an image recording apparatus 3 shown in FIG. 1;

FIG. 6 shows a flowchart of an output image data creation processing to be implemented by a CPU 21 shown in FIG. 2;

FIG. 7 shows an upper-lower direction of an image represented by the image data created by an image data creating apparatus 1;

FIG. 8 shows examples of a position confirming screen 231 displayed on a display section 23 shown in FIG. 2;

FIG. 9 shows a flowchart of a second format processing to be executed by the CPU 21 shown in FIG. 2;

FIG. 10 shows an example of film position information;

FIG. 11 shows an alignment mode of a film F at the time of an exposure/scanning operation in an image recording apparatus 3;

FIG. 12 shows schematic diagrams of format conversions to be conducted in a second format processing, when an alignment mode of a film F at the time of an exposure/scanning operation is the same as that shown in FIG. 11 in an image recording apparatus 3;

FIG. 13 shows an alignment mode of a film F at the time of an exposure/scanning operation in an image recording apparatus 3;

FIG. 14 shows schematic diagrams of format conversions to be conducted in a second format processing, when an alignment mode of a film F at the time of an exposure/scanning operation is the same as that shown in FIG. 13 in an image recording apparatus 3;

FIG. 15 shows an alignment mode of a film F at the time of an exposure/scanning operation in an image recording apparatus 3;

FIG. 16 shows schematic diagrams of format conversions to be conducted in a second format processing, when an alignment mode of a film F at the time of an exposure/scanning operation is the same as that shown in FIG. 15 in an image recording apparatus 3;

FIG. 17 shows schematic diagrams of other format conversions to be conducted in a second format processing, when an alignment mode of a film F at the time of an exposure/scanning operation is the same as that shown in FIG. 15 in an image recording apparatus 3; and

FIG. 18(a) shows an explanatory schematic diagram for explaining problem points, when a film size is larger than a data size, while FIG. 18(b) shows an explanatory schematic diagram for explaining problem points, when a film size is smaller than the data size.

According to the present invention, the following effects can be attained.

(1) In the breast image processing system that includes: an image creating apparatus that separately radiographs a left breast and a right breast of a same patient so as to create left breast image and right breast image; a processing apparatus to apply format processing to each of the left breast image and the right breast image, both created by the image creating apparatus; and an image recording apparatus that records the left breast image and the right breast image to each of which the format processing is applied by the processing apparatus onto a recording medium so as to output them, the processing apparatus applies the format processing to each of the left breast image and the right breast image in such a manner that each of a chest wall portion of the left breast image and a chest wall portion of the right breast image is positioned at a writing commencement position in the image recording apparatus. Accordingly, it becomes possible to prevent such the inconvenience that the image of the chest wall portion important for making diagnosis is dropped out, and/or the skipping area (transparent area) is generated in the vicinity of the chest wall portion, due to a size error or deviation of the recording medium.
(2) The processing apparatus adjusts a position of at least one of the left breast image and the right breast image, when the left breast image and the right breast image created by the image creating apparatus are aligned in a left-right direction in such a manner that a chest wall side of the left breast image and a chest wall side of the right breast image match with each other, so that positions of left and right breasts in the left breast image and the right breast image in an upper-lower direction substantially coincide with each other, and then, applies the format processing to each of the left breast image and the right breast image. Accordingly, since the positions of the left and right breasts are aligned with each other when the left and right breast images are loaded on the film viewer while placing them side by side in the left-to-right direction, it becomes possible for the doctor to easily conduct the comparing film-image observation, instead of conducting such the conventional comparing film-image observation method that the doctor takes out one of the breast images, to adjust its position in an upper-lower direction by hand so as to match it with that of the other breast image, and then, the doctor observes both breast image while pushing them against the film viewer so as to fix them at the adjusted positions. As a result, it also becomes possible for the doctor to efficiently conduct the comparing film-image observation.
(3) It becomes possible for the processing apparatus to acquire information with respect to a layout of the recording medium when writing the image onto the recording medium in the image recording apparatus, and then, corresponding to the acquired information, to apply the format processing to each of the left breast image and the right breast image in such a manner that each of a chest wall portion of the left breast image and a chest wall portion of the right breast image is positioned at a writing commencement position in the image recording apparatus.
(4) Since the image creating apparatus, the processing apparatus and the image recording apparatus are coupled to each other through communication network, it becomes possible to couple a plurality of image recording apparatuses to the single processing apparatus.
(5) When a plurality of image recording apparatuses are coupled to the breast image processing system, the processing apparatus acquires the information, with respect to the layout of the recording medium when writing the image onto the recording medium, from each of the plurality of image recording apparatuses, and then, applies format processing to each of the left breast image and the right breast image, based on the acquired information corresponding to the image recording apparatus to be an output destination of each of the left breast image and the right breast image. Accordingly, when the processing apparatus is coupled to a plurality of image recording apparatuses, it becomes possible for the processing apparatus to apply the format processing corresponding to each of the plurality of image recording apparatuses.
(6) The image recording apparatus is provided with: a conveyance means for conveying the recording medium one by one; an exposure scanning means for forming the image onto the recording medium by conducting an exposure/scanning operation for the recording medium conveyed by the conveyance means; and a position regulating means for conducting a position regulating operation, so that one side of the recording medium coincides with a exposure/scanning commencement position by the exposure scanning means; and the processing apparatus applies the format processing, so that each of the chest wall portion of the left breast image and the chest wall portion of the right breast image is positioned at the one side, the position of which is regulated by the position regulating means. Accordingly, it becomes possible to prevent such the inconvenience that the image of the chest wall portion important for making diagnosis is dropped out, and/or the skipping area (transparent area) is generated in the vicinity of the chest wall portion, due to a size error or deviation of the recording medium.
(6) The image recording apparatus is provided with: a conveyance means for conveying the recording medium one by one; an exposure scanning means for forming the image onto the recording medium by conducting an exposure/scanning operation for the recording medium conveyed by the conveyance means; and a write control means for controlling an image forming timing from a leading edge side in a conveyance direction of the recording medium; and the processing apparatus applies the format processing, so that each of the chest wall portion of the left breast image and the chest wall portion of the right breast image is positioned at the leading edge side in the conveyance direction of the recording medium. Accordingly, it becomes possible to prevent such the inconvenience that the image of the chest wall portion important for making diagnosis is dropped out, and/or the skipping area (transparent area) is generated in the vicinity of the chest wall portion, due to a size error or deviation of the recording medium.
(7) The image recording apparatus is provided with: a conveyance means for conveying the recording medium one by one; an exposure scanning means for forming the image onto the recording medium by conducting an exposure/scanning operation for the recording medium conveyed by the conveyance means; and a write control means for controlling an image forming timing from a leading edge side in a conveyance direction of the recording medium, and for creating a non-exposure area at a leading edge portion; and the processing apparatus applies the format processing, so that each of the chest wall portion of the left breast image and the chest wall portion of the right breast image is disposed at a position being apart from the leading edge side by a predetermined distance in the conveyance direction of the recording medium. Accordingly, it becomes possible to prevent such the inconvenience that the image of the chest wall portion important for making diagnosis is dropped out, and/or the skipping area (transparent area) is generated in the vicinity of the chest wall portion, due to a size error or deviation of the recording medium.

While the preferred embodiments of the present invention have been described using specific term, such description is for illustrative purpose only, and it is to be understood that changes and variations may be made without departing from the spirit and scope of the appended claims.

### BEST MODE FOR IMPLEMENTING THE INVENTION

Initially, an embodiment of the present invention will be detailed in the following.

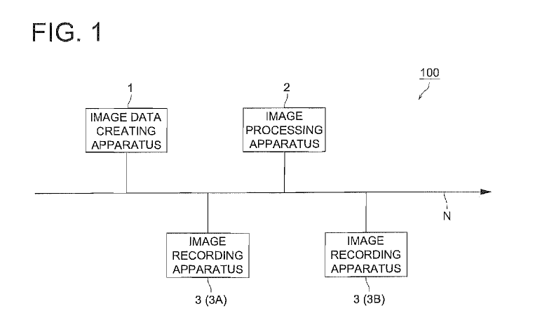

FIG. 1 shows a conceptual block diagram indicating an overall configuration of a breast image processing system 100 embodied in the present invention. As shown in FIG. 1, the breast image processing system 100 is constituted by an image data creating apparatus 1, an image processing apparatus 2, an image recording apparatus 3, etc., which are coupled to each other through a communication network N (hereinafter, referred to as a network N) in such a manner that various kinds of data can be bilaterally communicated between them.

In this connection, although an example in which the image data creating apparatus 1, the image processing apparatus 2 and the image recording apparatus 3 are coupled to each other through the network N will be detailed as the embodiment of the present invention in the following, the scope of the present invention is not limited to the above. The system configuration in which the above-mentioned apparatuses are connected to each other through direct wire coupling paths is also applicable as the present invention. Further, a number of apparatuses and/or an installation site are not specifically limited in the present invention.

Various kinds of communication network modes, such as a LAN (Local Area Network), a WAN (Wide Area Network), an Internet, etc., are applicable as the network N of the present invention. In this connection, if permitted in the medical installation, such as a hospital, etc., a wireless communication and/or an infrared communication is also applicable as the network N. However, since the data to be communicated between them generally includes important patient information, it is preferable that the data should be encrypted. Further, generally speaking, the DICOM (Digital Image and Communication in Medicine) protocol is employed for the communication method within the hospital. Accordingly, the DICOM MWM (Modality Work-list Management) and/or the DICOM MPPS (Modality Performed Procedure Step) are/is employed for the communications between the apparatuses coupled through the network N mentioned in the above.

The image data creating apparatus 1 includes various kinds of modalities, such as a CT (Computed Tomography), a MRI (Magnetic Resonance Imaging), a CR (Computed Radiography), a FPD (Flat Panel Detector), etc., each of which captures a medical image of the human body and converts the captured image to digital image data, so as to generate medical image data. In the present embodiment to be detailed in the following, the image data creating apparatus 1 is assumed as the CR apparatus that is provided with a breast image capturing device to individually radiograph the left and right breasts by employing cassettes, a reader to read the radiographic image information stored in the cassettes so as to generate the medical image data of the left and right breast images, etc. Hereinafter, the cassette is defined as a radiographic image conversion medium in which a stimulative phosphor sheet for storing energy of the radial rays is incorporated and which is mobile.

Further, since the image data creating apparatus 1 is in conformity with the DICOM protocol aforementioned, it is possible to input DICOM image associating information (hereinafter, referred to as associate information) in regard to the breast images or to automatically generate the associate information. The image data creating apparatus 1 can output not only the generated medical image data of the breast image, but also the associate information to the image processing apparatus 2 as its header information through the network N. Further, when the associate information do not conform to the DICOM protocol, a DICOM conversion apparatus (not shown in the drawings) is employed for inputting such the associate information.

For instance, the associate information of the breast image includes patient information, such as a name of patient radiographed, a patient ID, an age of patient, a sexuality, etc., and radiographing information, such as a date of radiographing, an inspection ID, a name of radiographed portion, radiographing conditions (left or right of radiographed breast image, a radiographing direction, etc.), information in regard to the image data creating apparatus employed (a kind of modality), etc.

The image processing apparatus 2 serves as such a processing apparatus that applies the image processing and the format processing for improving the efficiency of the film reading diagnosis conducted by the doctor to the medical image data, so as to generate the processed medical image data representing the output medical image to be outputted to the image recording apparatus 3.

Next, the internal configuration of the image processing apparatus 2 will be detailed in the following.

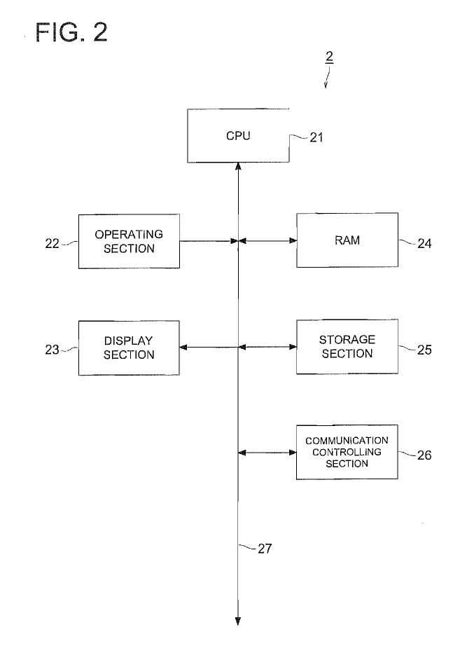

FIG. 2 shows a block diagram of a functional configuration of the image processing apparatus 2. As shown in FIG. 2, the image processing apparatus 2 is constituted by a CPU (Central Processing Unit) 21, an operating section 22, a display section 23, a RAM (Random Access Memory) 24, a storage section 25, a communication controlling section 26, etc., which are coupled to each other through a bus 27.

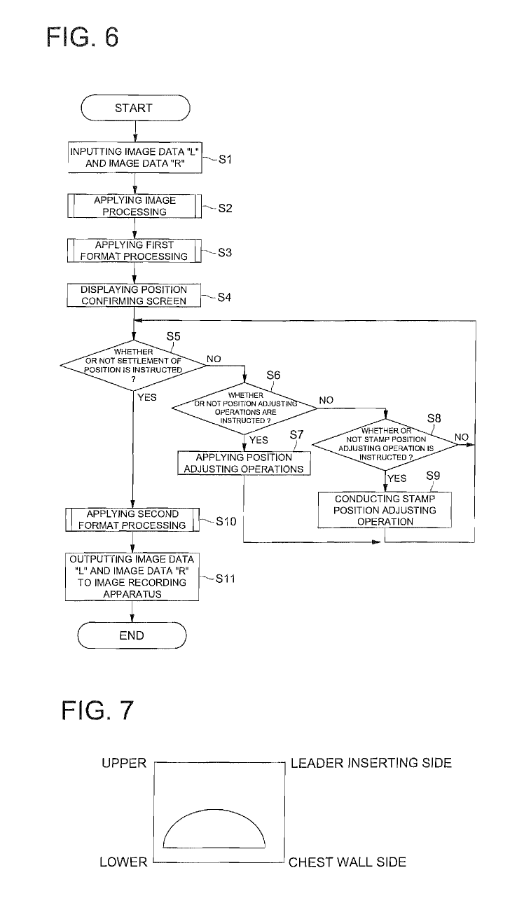

The CPU 21 reads out a system program stored in the storage section 25 and develops the system program into a working area created in the RAM 24, so as to control the sections concerned, according to the system program developed. Further, the CPU 21 also reads out various kinds of processing programs, such as an output image data creating/processing program, an image processing program, a first format processing program, a second format processing program, etc., and various kinds of application programs, which are stored in the storage section 25, and develops each of them into a corresponding working area created in the PAM 24, so as to implement various kinds of processing, such as an output image data creation processing detailed later referring to FIG. 6, etc.

The operating section 22 is provided with a keyboard, including a cursor key, ten keys, various kinds of function keys, etc., and a pointing device, such as a mouse, etc., so as to output the instruction signals, inputted by operating the keyboard and the mouse, to the CPU 21. Further, it is also applicable that the operating section 22 is constituted by a touch panel provided on a display screen of the display section 23, and in this configuration, the instruction signals inputted trough the touch panel are outputted to the CPU 21.

The display section 23 includes a display monitor, such as a LCD (Liquid Crystal Display), a CRT monitor, etc., in order to display the instructions and the data inputted from the operating section 22, according to the display command signals sent from the CPU 21.

The RAM 24 creates the working areas into which various kinds of programs executable by the CPU 21 and read out from the storage section 25, inputted or outputted data, various kinds of parameters, etc., which are implemented and controlled by the CPU 21 in various kinds of processing, are temporarily stored.

The storage section 25 is constituted by a HDD (Hard Disc Drive), a nonvolatile semiconductor memory, etc., so as to store the system program to be executed by the CPU 21, the various kinds of processing programs corresponding to the system program, such as the output image data creating/processing program, the image processing program, the first format processing program, the second format processing program, etc., the various kinds of application programs, various kinds of data, etc. The abovementioned various kinds of programs are stored in a mode of readable program codes, so that the CPU 21 can execute each of the abovementioned various kinds of programs as needed, according to the program code concerned.

The communication controlling section 26 is provided with a LAN adaptor, a router, a TA (Terminal Adaptor), etc., so as to control the communications to be conducted between the apparatuses coupled to each other through the network N.

The image recording apparatus 3 shown in FIG. 1 is such a printer that employs the medical laser exposing and heat developing method and records the medical image on the recording medium (herein, a film F) based on the output image data received from the image processing apparatus 2, so as to output a hardcopy having a reproduced visible image on it.

Successively, the internal configuration of the image recording apparatus 3 will be detailed in the following.

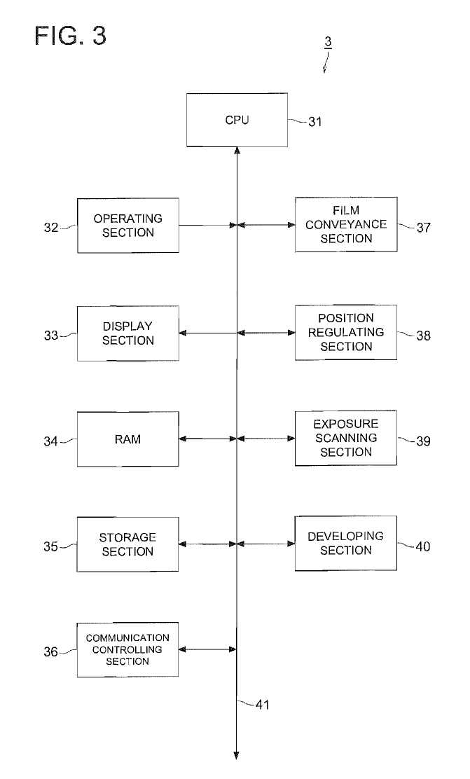

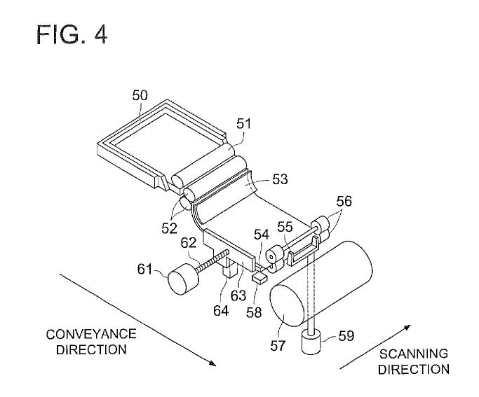

FIG. 3 shows a block diagram indicating a functional configuration of the image recording apparatus 3. FIG. 4 shows a perspective view indicating a brief structure of a film conveyance section 37 and a position regulating section 38 provided in the image recording apparatus 3.

As shown in FIG. 3, the image recording apparatus 3 is constituted by a CPU (Central Processing Unit) 31, an operating section 32, a display section 33, a RAM (Random Access Memory) 34, a storage section 35, a communication controlling section 36, the film conveyance section 37, the position regulating section 38, an exposure scanning section 39, a developing section 40, etc., which are coupled to each other through a bus 41.

The CPU 31 reads out a system program stored in the storage section 35 and develops the system program into a working area created in the RAM 34, so as to control the sections concerned, according to the system program developed.

The operating section 32 is constituted by, for instance, a touch panel integrally formed on a display screen of the display section 33. The touch panel receives input touch actions conducted onto the display screen of the display section 33 by the user, and outputs the inputted signals to the CPU 31.

The display section 33 includes a display monitor, such as a LCD (Liquid Crystal Display), etc., in order to display information concerning to operations of the image recording apparatus 3, information concerning to the status of the image recording apparatus 3, etc. on the display screen, according to the display command signals sent from the CPU 31.

The RAM 34 creates the working areas into which various kinds of programs to be executed by the CPU 31 and the output image data to be inputted through the communication controlling section 36, etc. are temporarily stored.

The storage section 35 is constituted by a ROM (Read Only Memory), a nonvolatile semiconductor memory, etc., so as to store the system program to be executed by the CPU 31, the various kinds of processing programs corresponding to the system program concerned, various kinds of data, etc.

The communication controlling section 36 is provided with a LAN adaptor, a router, a TA (Terminal Adaptor), etc., so as to control the communications to be conducted between the apparatuses coupled to each other through the network N.

As shown in FIG. 4, the film conveyance section 37 is constituted by: a film sheet feeding tray 50; a feeding roller 51 to pick up and feed the film F one by one from the film sheet feeding tray 50; a conveyance roller 52 to convey the film F fed by feeding roller 51; a guide plate 53 to guide the film F conveyed by the conveyance roller 52; a bottom plate 54 to support the film F; a stopper nail 55 to stop the film F; a registration roller 56 to introduce the film F onto a drum 57; the drum 57 to guide the film F at the time of the exposure scanning operation; a detecting sensor 58 to detect a fact that the film F arrives at a predetermined position; a solenoid 59 to move the stopper nail 55 to a standby position; etc., which are operated on the basis of control signals sent from the CPU 31, so as to convey the film F picked up one by one from plural films loaded into the film sheet feeding tray 50 in the conveyance direction.

The position regulating section 38 determines a position of the film F, so that one side edge of the film F is positioned at such a position that establishes a predetermined positional relationship with respect to the exposure scanning section 39, namely, so that one side edge of the film F coincides with an exposure scanning commencement position (writing commencement position) H. For instance, as shown in FIG. 4, the position regulating section 38 is constituted by: a motor 61; a screw 62 integrally coupled to the rotating axis of the motor 61; a width shifting plate 63; a switch 64; etc. In the above configuration of the position regulating section 38, when the switch 64 turns ON, based on the control signal sent from the CPU 31, the screw 62 rotates with the rotation of the motor 61, so as to shift the width shifting plate 63 geared with the screw 62 in a direction parallel to the scanning direction, and accordingly, one side edge of the film F moves towards the exposure scanning commencement position H. When the one side edge of the film F arrives at the exposure scanning commencement position H, the switch 64 turns OFF, and finally, the position of the film F is determined.

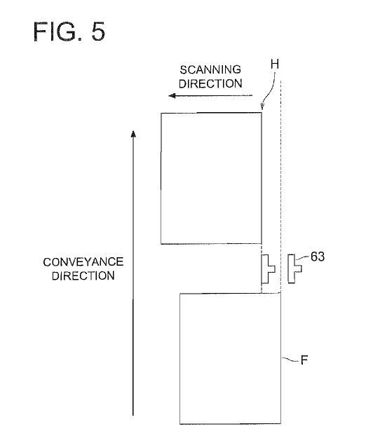

In this connection, as shown in FIG. 5, when conveying the film F, the film F is shifted in advance in a direction opposite to the scanning direction, so that the side edge of the film F deviates outside from the exposure scanning commencement position H at which the position regulating section 38 regulates the position of the film F, in order to securely conduct the position regulating action of the width shifting plate 63.

Further, although, in the configuration shown in FIG. 4 and FIG. 5, the position regulating section 38 is disposed at the right side position with respect to the conveyance direction, when the scanning direction is set at a left-to-right direction, it is preferable that the position regulating section 38 is disposed at a left side position with respect to the conveyance direction.

The exposure scanning section 39 is constituted by: a pulse width modulating section (not shown in the drawings); a rotating polygon mirror; focusing lenses, such as an fO lens, etc.; etc., so as to form an image on the film F by exposure-scanning a laser beam modulated by the inputted image signals onto the film F, based on the control signals sent from the CPU 31. The exposure scanning section 39 commences the exposure scanning operation at the timing when the image forming operation is commenced from the side edge of the leading edge of the film F in the conveyance direction, under the controlling actions of the CPU 31 serving as a write control section.

The developing section 40 is constituted by: a heat roller (not shown in the drawings); and an opposing roller, disposed opposite to the heat roller, to make the film F press-contact the heat roller; so as to apply the thermal develop processing to the exposed film F, and outputs the film F having the developed image.

Next, the operations of the present embodiment will be detailed in the following.

FIG. 6 shows a flowchart of an output image data creation processing to be implemented by the CPU 21 of the image processing apparatus 2. The CPU 21 serves as the position adjusting section and the format processing section, embodied in the present invention, by executing software processing in corporation with the output image data creation program stored in the storage section 25 so as to implement the output image data creation processing concerned.

At first, image data of a left breast image acquired by radiographing a left breast of a patient (hereinafter, referred to as image data “L”) and image data of a right breast image acquired by radiographing a right breast of the same patient (hereinafter, referred to as image data “R”) are inputted into the image processing apparatus 2 through the communication controlling section 26 from the image data creating apparatus 1, and then, stored in the working area created in the RAM 24 (Step S1). Successively, the CPU 21 reads out the image processing program, in order to apply the image processing for correcting the image quality to the image data “L” and image data “R”, respectively (Step S2).

The abovementioned image processing include a gradation processing to adjust the contrast of the image, a frequency processing to adjust the sharpness of the image, a dynamic range compression processing to compress the wide dynamic range of the image to such an extent where the image can be easily seen without deteriorating the contrast of the details of the subject, etc. Further, the image data “L” and the image data “R” are analyzed so as to recognize the subject areas, and then, the gradation processing is applied to the image data “L” and the image data “R”, so that densities of areas other than the recognized subject areas are set at values greater than a predetermined density value, for instance, the density values are greater than the minimum density value in the subject areas. The abovementioned gradation processing is employed for suppressing the influence of the light, emitted from the light source of the film viewer and penetrated through the film F, when observing the medical images.

The recognition of the subject areas is achieved by analyzing the image data “L” and the image data “R” so as to extract contour lines of the subject images. For instance, the density data of the image data “L” and the image data “R” are binarized by employing an appropriate threshold value, and the contour lines are established by tracing the boundary between “0” and “1”, so that the subject areas are determined corresponding to the above contour lines, the radiographed parts, the radiographing postures and the radiographing directions. Alternatively, it is also applicable that “METHOD FOR EXTRACTING CONTOUR LINE OF AREA CORRESPONDING TO PREDETERMINED ANATOMICAL STRUCTURE OF INSIDE HUMAN BODY OR HUMAN BODY AREA” (set forth in Japanese breast cancer examination society magazine, No. 1, pp 87-102, 1998, Tokkaisho 63-240832, Japanese Non-Examined Patent Publication) is employed for determining the subject areas.

Successively, the CPU 21 reads out the first format processing program, in order to apply the first format processing to the image data “L” and image data “R”, respectively (Step S3). The first format processing is applied to both the image data “L” and image data “R”, to both of which the image processing are already applied, in order to create such a display image that is formed by aligning the left and right breast images side by side while matching the chest sides of them with each other. For instance, when the image data creating apparatus 1 recognizes the image data “L” and the image data “R” as the images in which the chest sides are positioned at a lower side, as shown in FIG. 7, based on the leader inserting direction of the cassette, the image represented by the image data “L” determined from its associate information, is rotated counterclockwise to 90 degrees and placed at the left side position on the display screen, while the image represented by the image data “R” determined from its associate information, is rotated clockwise to 90 degrees and placed at the right side position on the display screen. Further, stamp information, such as discrimination of left or right of the breast image, patient information in regard to the breast image concerned, etc., are created on the basis of the associate information, and are allotted to predetermined positions on the breast image concerned.

Successively, the left and right breast images, represented by the image data “L” and the image data “R” to both of which the first format processing is already applied, are displayed on the display section 23 as a position confirming screen 231 (Step S4).

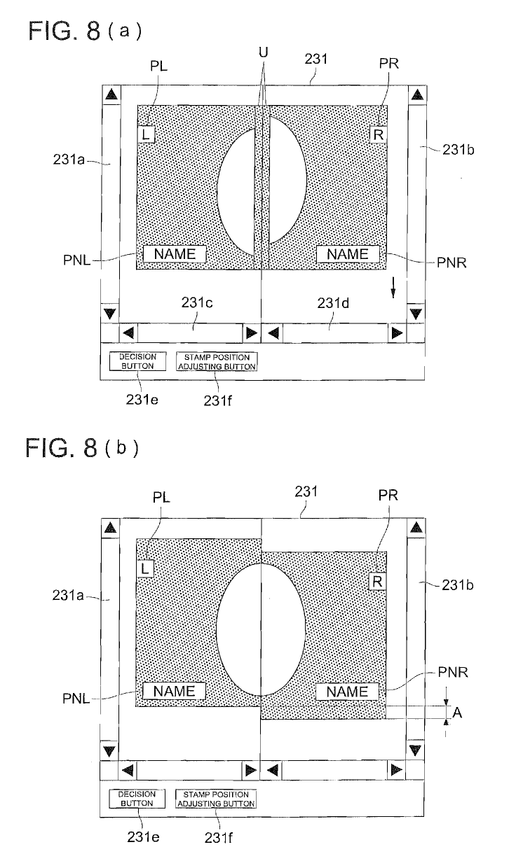

FIG. 8(a) and FIG. 8(b) show examples of the position confirming screen 231. As shown in FIG. 8(a) and FIG. 8(b), the breast images represented by the image data “L” and the image data “R” are disposed side by side on the position confirming screen 231, in such a manner that the chest wall portions of the left and right breast images match with each other. Accordingly, it becomes possible to confirm the positional relationship between the left and right breast images, when the hardcopies of the left and right breast images are aligned on the film viewer. Scrawl bars 231a, 231b, 231c, 231d are displayed on the left/right side portions and the lower portions of the position confirming screen 231. When the scrawl bar 231a is operated by employing the mouse of the operating section 22, the position of the left breast image displayed on the screen is adjusted in the upper-lower direction. When the scrawl bar 231b is operated by employing the mouse of the operating section 22, the position of the right breast image displayed on the screen is adjusted in the upper-lower direction. When the scrawl bar 231c is operated by employing the mouse of the operating section 22, the position of the left breast image displayed on the screen is adjusted in the left-right direction. When the scrawl bar 231d is operated by employing the mouse of the operating section 22, the position of the right breast image displayed on the screen is adjusted in the left-right direction.

For instance, when the position confirming screen 231 shown in FIG. 8(a) is displayed in the Step S3, if the hardcopies are outputted without conducting the position adjusting operation and loaded on the film viewer as it is, the position of the right breast image deviates from that of the left breast image in the upper direction. To avoid the above inconvenience, by operating the lower arrow of the scrawl bar 231b, the right breast image represented by the image data “R” can be shifted in the lower direction by a length A with reference to the position of the left breast image represented by the image data “L”, so as to substantially match the positions of left and right breast images with each other as shown in FIG. 8(b).

Further, when a non-breast image portion U exists at the chest wall portion of each of the left and right breast images as shown in FIG. 8(a), it becomes possible to adjust each position of the left and right breast images in such a manner that the position of the chest wall is made to approach the edge of the image area of the breast image, so as to make it easy to conduct the comparing film-image observation. In this connection, when it is determined by the subject recognition processing, included in the aforementioned image processing, that the non-breast image portion U exists at the chest wall portion of each of the left and right breast images, it is also applicable that image data representing the non-breast image portion U are deleted in advance from either the image data “L” or the image data “R”.

Still further, a stamp position adjusting button 231f is also displayed on the position confirming screen 231. When the stamp position adjusting button 231f is operated by employing the mouse, etc., included in the operating section 22, stamp information PL, PR, indicating either the left or the right breast image, and stamp information PNL, PNR, indicating the patient information, enter into standby status for waiting the position adjusting operation, so as to make it possible to move the stamp information, the position of which is desired to be adjusted, by conducting the dragging operation, etc. In FIG. 8(b), there shows the fact that the positions of the stamp information PR and the stamp information PNR are adjusted in conjunction with the position adjusting operation of the right breast image represented by the image data “R”.

After the position adjusting operations with respect to the left and right breast images and the stamp information are completed, when a decision button 231e, disposed at the left-lower position of the position confirming screen 231, is operated by employing the mouse, etc., included in the operating section 22, it is possible to settle the position adjusting operations.

Incidentally, although the left and right breast images respectively represented by the image data “L” and the image data “R”, are indicated as CC images acquired by radiographing the breasts in the upper-lower direction, in the FIG. 8(a) and FIG. 8(b), it is also possible to apply the position adjusting operations to MLO images acquired by radiographing the breasts in an inclined direction, as well.

Further, although an example, in which the position adjusting operations is achieved by shifting the position of the image data “R” with reference to the position of the image data “L”, has been indicated in the foregoing, it is also applicable that the position adjusting operations is achieved by shifting the position of the image data “L” with reference to the position of the image data “R”.

Still further, it is also applicable that, after the position adjusting operations in respect to the image data “L” and the image data “R” are completed and settled, a frame equivalent to the film frame (frame of the output image), to be employed in the image recording apparatus 3, is displayed on the display screen, and then, the left and right breast images after the position adjusting operations are integrally shifted in the upper-lower direction, so as to adjust the positions of the breast images within a range of the film frame to be outputted.

Yet further, it is also applicable that the radiographing direction is also indicated on the stamp information PL, PR in addition to the indication of either left or right breast image (for instance, CC-L, CC-R, MLO-L, MLO-R).

Returning to FIG. 6, when the settlement of the positions is instructed from the position confirming screen 231 (Step S5; YES), the processing proceeds into Step S10. When the settlement of the positions is not instructed (Step S5; NO), but the position adjusting operations of the image data “L” and the image data “R” are instructed from the position confirming screen 231 by operating the operating section 22 (Step S6), the position adjusting operations in respect to the left and right breast images are applied to the image data “L” and the image data “R”, in response to the operations conducted on the operating section 22 (Step S7), and then, the processing returns to Step S5. When the position adjusting operations in respect to the stamp information are instructed by operating the stamp position adjusting button 231f (Step S8; YES), each of the stamp information is moved in response to the operations conducted on the operating section 22 (Step S9), and then, the processing returns to Step S5. After adjusting the positions of the image data “L”, image data “R” and the stamp information, when the settlement of the positions is instructed (Step S5; YES), the processing proceeds into Step S10. At this time, the position adjusting results of the image data, namely, an adjusting amount and positional information of the stamp information, are stored in the RAM 24 as the position adjusting information.

When the relative positional relationship between the left and right breast images and the positions of the stamp information are settled, the second format processing is applied to each of the image data “L” and the image data “R”, so as to convert them to output image data “L” and output image data “R”, a format of which conforms to the recording method for forming an image on the film F in the image recording apparatus 3 (Step S10).

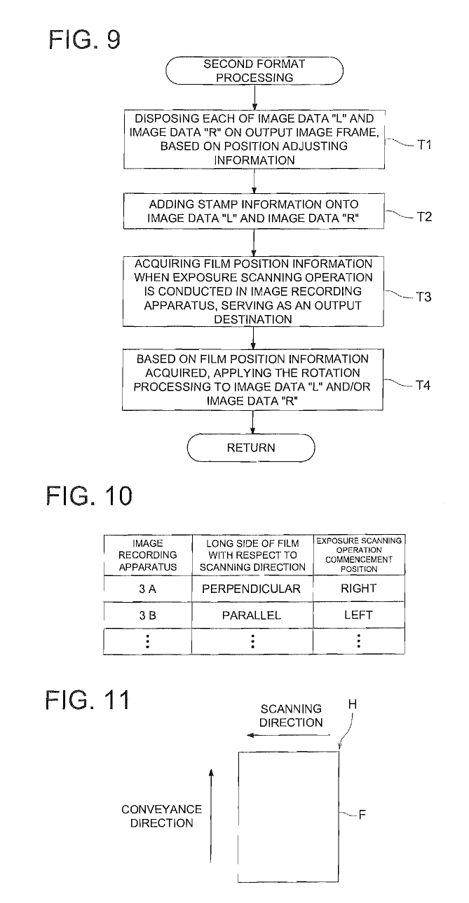

FIG. 9 shows a flowchart of the second format processing.

Initially, an output image frame, a size of which corresponds to the film size to be employed in the image recording apparatus 3 (hereinafter, assumed as 8×10 inch size), is established, and then, the image data “L” and the image data “R” rotated in the first format processing are individually disposed on the output image frame (Step T1). When the position adjusting operations are conducted from the position confirming screen 231, each of the left and right breast images is disposed onto the output image frame, based on the position adjusting information serving as the position adjusting results (namely, the information indicating the direction and amount of the adjustment concerned, for instance, in the case shown in FIG. 8(b), the information indicating that the image data “R” is shifted downward by the length A). For instance, in the case that the position adjusting operations shown in FIG. 8(b) were applied, each of the image data “L” and the image data “R” is disposed onto the output image frame in such a manner that the image data “R” is shifted downward by the length A with respect to the image data “L” The image data, which are not contained within the output image frame as a result of the position adjusting operation, are deleted. Further, when a vacant area in which no image data exist is created as a result of the position adjusting operation, a black conversion processing (conversion to a density value higher than a predetermined density value, for instance, conversion to a high density value higher than a minimum density value within a density range of the subject area) is applied to such the vacant area.

Successively, based on the positional information of the stamp information settled on the position adjusting screen, the stamp information are added onto the image data (Step T2).

Still successively, film position information indicating a position of the film when the exposure scanning operation is conducted in the image recording apparatus 3 serving as an output destination of the image concerned (hereinafter, referred to as film position information, for simplicity) are acquired (Step T3; acquiring section), and then, based on the film position information acquired in the above, the rotation processing is applied to the image data “L” and/or the image data “R” (Step T4). Then, the processing proceeds into Step S11 shown in FIG. 6.

The film position information indicates how to allocate the film F with respect to the scanning direction when the exposure scanning section 39 writes the image on the film F. Concretely speaking, the information indicating how to dispose the long side of the film F with respect to the scanning direction (namely, whether the long side of the film F is disposed in a direction perpendicular to the scanning direction or in a direction parallel to the scanning direction), and/or the other information indicating whether the exposure scanning commencement position H is set at the right side or the left side with respect to the conveyance direction of the film F, etc., can be cited as the film position information mentioned in the above. It is applicable that the film position information are acquired in advance by inquiring each of the image recording apparatuses 3A, 3B - - - coupled to the network N so as to store them in the storage section 35, as shown in FIG. 10, and after that, the film position information corresponding to the image recording apparatus 3, serving as the output destination of the image concerned, are acquired by reading them from the storage section 35 in Step T3. Alternatively, in Step T3, it is also applicable that the film position information are acquired by inquiring the image recording apparatus 3, serving as the output destination of the image concerned, through the network N.

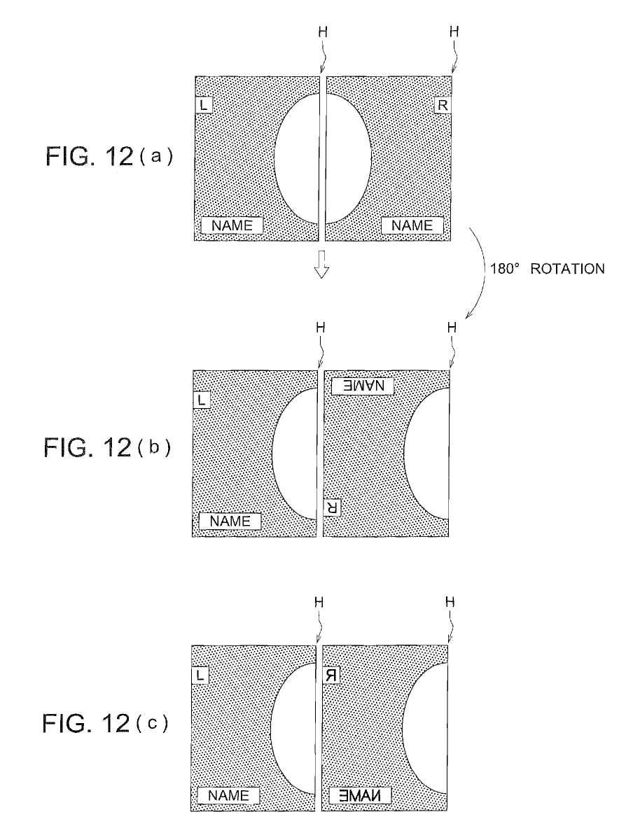

When the film F is aligned in such a manner as shown in FIG. 11 at the time of the exposure scanning operation conducted in the image recording apparatus 3, namely, when the long side of the film F is perpendicular to the scanning direction and the exposure scanning commencement position H is set at the right side with respect to the conveyance direction of the film F, assuming that an image represented by each of the image data “L” and the image data “R”, rotated in such a manner as shown in FIG. 12(a) in the first format processing, is written onto the film F in this format as it is, since the position regulating section 38 regulates the position of the film F so that the exposure scanning commencement position H coincides with the right side of the film F when writing the image represented by the image data “L”, neither the transparent area nor the lack of information would be generated at the chest wall portion to be disposed at the right side of the image concerned. However, when writing the image represented by the image data “R”, since the chest wall portion is disposed opposite to the exposure scanning commencement position H, there is a fear that the transparent area or the lack of information would be possibly generated at the chest wall portion important for making diagnosis, due to variations of the film length and/or subtle deviations generated during the conveyance operation, etc.

Accordingly, when the film F is aligned in such a manner as shown in FIG. 11 at the time of the exposure scanning operation conducted in the image recording apparatus 3, the image data “R” is rotated up to 180 degrees in parallel to the image surface and converted from the state shown in FIG. 12(a) to the other state shown in FIG. 12(b), so that the chest wall portion is placed at the right side being the same as the exposure scanning commencement position H when the image represented by the image data “L” is written in the image recording apparatus 3. When the film F is a transparent type film and the physical properties of the both surfaces of the film F (such as a surface glossiness, a reflectivity, etc.) are substantially the same (for instance, a photosensitive material for dry use, in which the luminance difference between the BC surface and the Em surface is small), it is also applicable that the image data “R” indicated in FIG. 12(a) are converted to the state indicated in FIG. 12(c) by inversing (mirroring) it in the left-to-right direction.

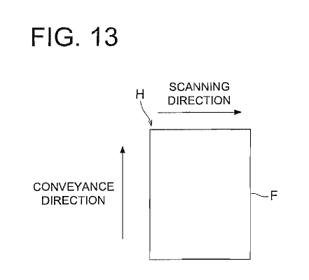

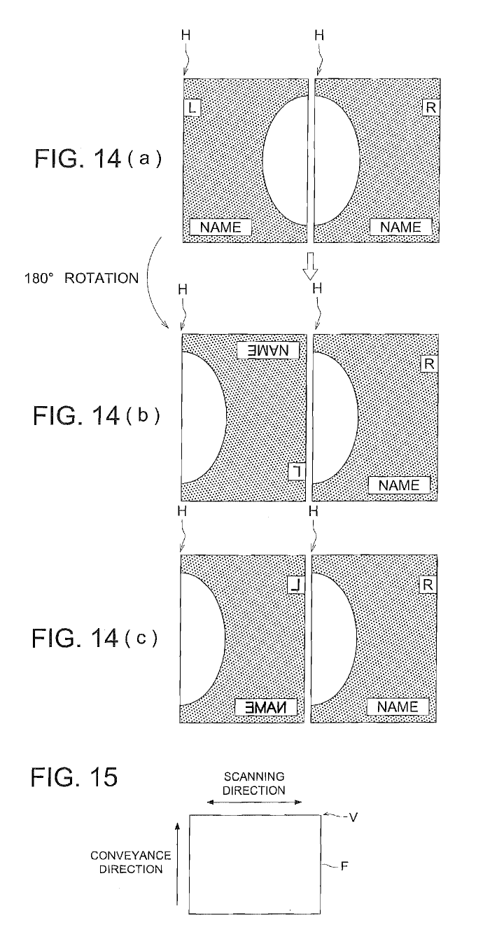

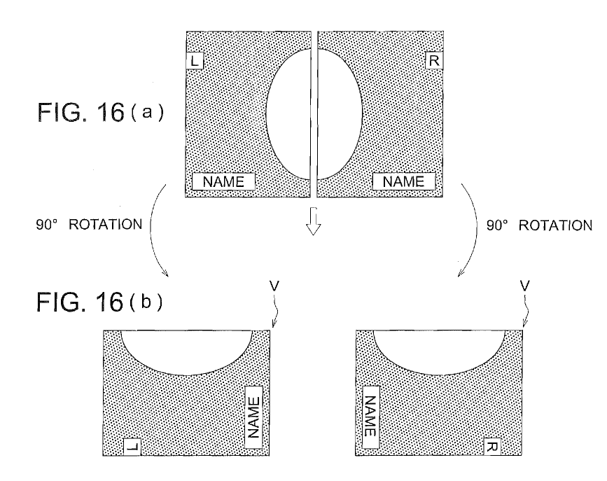

On the other hand, when the film F is aligned in such a manner as shown in FIG. 13 at the time of the exposure scanning operation conducted in the image recording apparatus 3, namely, when the long side of the film F is perpendicular to the scanning direction and the exposure scanning commencement position H is set at the left side with respect to the conveyance direction of the film F, assuming that an image represented by each of the image data “L” and the image data “R”, rotated in such a manner as shown in FIG. 14(a) in the first format processing, is written onto the film F in this format as it is, since the position regulating section 38 regulates the position of the film F so that the exposure scanning commencement position H coincides with the left side of the film F when writing the image represented by the image data “R”, neither the transparent area nor the lack of information would be generated at the chest wall portion to be disposed at the left side of the image concerned. However, when writing the image represented by the image data “L”, since the chest wall portion is disposed opposite to the exposure scanning commencement position H, there is a fear that the transparent area or the lack of information would be possibly generated at the chest wall portion important for making diagnosis, due to variations of the film length and/or subtle deviations generated during the conveyance operation, etc.

Accordingly, when the film F is aligned in such a manner as shown in FIG. 13 at the time of the exposure scanning operation conducted in the image recording apparatus 3, the image data “L” is rotated up to 180 degrees in parallel to the image surface and converted from the state shown in FIG. 14(a) to the other state shown in FIG. 14(b), so that the chest wall portion is placed at the left side being the same as the exposure scanning commencement position H when the image represented by the image data “L” is written in the image recording apparatus 3. When the film F is a transparent type film and the physical properties of the both surfaces of the film F (such as a surface glossiness, a reflectivity, etc.) are substantially the same (for instance, a photosensitive material for dry use, in which the luminance difference between the BC surface and the Em surface is small), it is also applicable that the image data “L” indicated in FIG. 14(a) are converted to the state indicated in FIG. 14(c) by inversing (mirroring) it in the left-to-right direction.

On the other hand, when the film F is aligned in such a manner as shown in FIG. 15 at the time of the exposure scanning operation conducted in the image recording apparatus 3, namely, when the long side of the film F is in parallel to the scanning direction, the image data “L” is rotated anticlockwise up to 90 degrees while the image data “R” is rotated clockwise up to 90 degrees, so that each of the chest wall portions of them is positioned at the leading edge side of the film F in its conveyance direction when recording the image concerned. Accordingly, since the CPU 31 controls an image forming timing V in the exposure scanning section 39 so as to commence the image writing operation from the leading edge side of the film F in the image recording apparatus 3, it becomes possible to prevent the chest wall portion from generating the skipping area (transparent area) or the lack of image information.

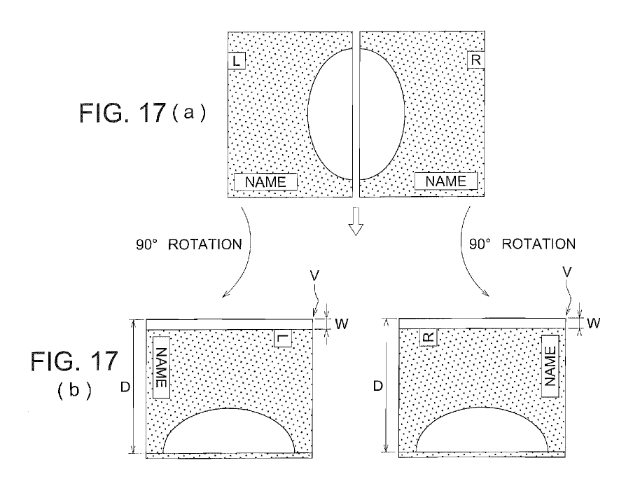

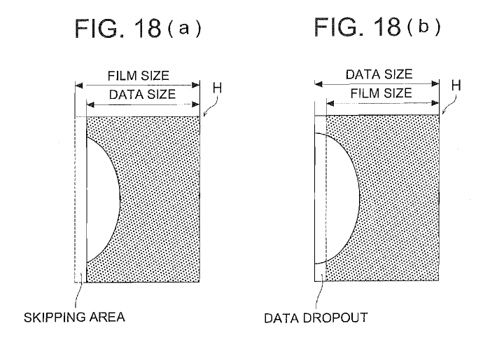

Further, when the film F is aligned in such a manner as shown in FIG. 15 at the time of the exposure scanning operation conducted in the image recording apparatus 3, it is also possible to operate the image recording apparatus 3 in such a manner as detailed in the following. As shown in FIG. 17(a) and FIG. 17(b), the image data “L” is rotated clockwise up to 90 degrees while the image data “R” is rotated anticlockwise up to 90 degrees, so that each of the chest wall portions of them is positioned in the vicinity of the trailing edge side of the film F in its conveyance direction when recording the image concerned. Further, the corresponding image data are (positionally) adjusted, so that a distance D from the leading edge side to the chest wall portion in the conveyance direction of the film F is kept constant. Considering the lack of image information at the chest wall portion due to the variations of the film F, it is preferable that the chest wall portion is set at such a position that is apart from the trailing edge side of the film F by a distance in a range of 0.5-1 mm. Although the above positional adjustment would delete a part of the image information at the leading edge side of the image data, since little information important for making diagnosis are included in the leading edge side, compared to those in the chest wall portion, the above deletion does not impede the diagnosis. On the other hand, to prevent the observer form being dazzled when observing the film image, the image data corresponding to the outputable maximum density are newly allotted to the area from the chest wall portion to the trailing edge of the film F in the same way as in the background area of the breast image. Further, with respect to this position-adjusted image data, the image data are corrected, so that image data of an area, corresponding to a width W (normally, in a range of 1-2 mm), represent the skipping area (transparent area, Dmin) when the image is outputted onto the film F (for instance, when the direct modulation method is employed, the signal values representing the predetermined densities are corrected (converted) to the value “0”, which represents such the signal value level that deactivates the light emitting action of the laser). Although a part of the image information at the leading edge side of the initial image data are also deleted even in the abovementioned correcting operation, since little information important for making diagnosis are included in the leading edge side, no problem would occur. In the image recording apparatus 3, the CPU 31 controls the section concerned, to conduct the image forming operation according to the format data created in the above process, so as to create the hardcopy in which the skipping area is created at the leading edge side of the film, the high density area is formed on the trailing edge side of the film, and the chest wall portion resides at the trailing edge side of the film.

Further, in such the case that the image recording apparatus 3 itself commences the image writing operation based on the image data from the position sifted from the leading edge side of the film by the width W, it is applicable that the format processing section sets a position correcting amount (data deleting amount of the leading edge portion of the original image data), which is derived by adding the width W to the position correcting amount of the abovementioned image data (data deleting amount of the leading edge portion of the original image data).

In this connection, since the overlapping positions of the patient name information and the radiograph position information (Left or Right) to be superimposed onto the image data are adjustable, it is preferable that such the overlapping positions originally set should be corrected to new positions, corresponding to the position correcting amount of the above image data, so as to avoid any lack of the information concerned.

In Step S11 shown in FIG. 6, the image data “L” and the image data “R”, both of which are created by applying the second format processing, are outputted to the image recording apparatus 3 designated as the output destination of the breast images concerned, and then, the format processing is finalized.

In the image recording apparatus 3, when the image data “L” and the image data “R” are received, under the controlling operations conducted by the CPU 31, the film conveyance section 37 picks up the film F one by one from the film sheet feeding tray 50 to convey it to the exposure scanning section 39. When the film F arrives at the stopper nail 55 shown in FIG. 4, the position regulating section 38 conducts the position regulating operation, in which the position of the film F is adjusted in such a manner that the exposure scanning commencement position H coincides with one side of the film F. Further, the CPU 31 controls the image forming timing of the exposure scanning section 39, so that the image is formed from the leading edge side in the conveyance direction of the film F, and the left and right breast images are individually formed on the films F to be outputted.

By loading the left and right breast images outputted in the abovementioned manner while rotating or inversing one of them so as to match the chest wall portions of them with each other, it becomes possible to implement the comparing film-image observation.

As detailed in the foregoing, according to the breast image processing system 100, when the image data “L” and the image data “R”, representing the left and right breast images and created in the image data creating apparatus 1, are inputted into the image processing apparatus 2, the image processing operations are applied to the image data “L” and the image data “R”, and the position confirming screen 231, in which the breast images are aligned side by side in the left-to-right direction in such a manner that the chest wall portions of the image data “L” and the image data “R” coincide with each other as a result of the first format processing, is displayed. The positions of the image data “L” and the image data “R” are adjusted on the position confirming screen 231 mentioned in the above. When the positions of the image data “L” and the image data “R” are settled, the second format processing is applied to them, based on the position adjustment results, so as to dispose each of them within the output frame, to delete image data representing the area outside the output frame, to apply the black conversion processing to the area having no image data within the output frame, etc. Further, at the same time, based on the film position information at the time of exposure scanning operation in the image recording apparatus 3 serving as the output destination, the format of the image data “L” and the image data “R” are converted so that the image data of the chest wall portions correspond to the exposure scanning commencement side, and the converted image data are outputted to the image recording apparatus 3.

In the image recording apparatus 3, when the image data “L” and the image data “R” are received, the film F is picked up one by one from the film sheet feeding tray 50 to convey it to the exposure scanning section 39. When the film F arrives at the stopper nail 55 shown in FIG. 4, the position regulating section 38 conducts the position regulating operation, in which the position of the film F is adjusted in such a manner that the exposure scanning commencement position H coincides with one side of the film F. Further, the CPU 31 controls the image forming timing of the exposure scanning section 39, so that the image is formed from the leading edge side in the conveyance direction of the film F, and the left and right breast images are individually formed on the films F to be outputted.

Accordingly, it becomes possible to prevent such the inconvenience that the image of the chest wall portion important for making diagnosis is dropped out, and/or the skipping area (transparent area) is generated in the vicinity of the chest wall portion. Further, since the positions of the left and right breasts are aligned with each other when the hardcopies of the left and right breast images are loaded on the film viewer while placing them side by side in the left-to-right direction, it becomes possible for the doctor to easily conduct the comparing film-image observation, instead of conducting such the conventional comparing film-image observation method that the doctor takes out one of the breast images, to adjust its position in an upper-lower direction by hand so as to match it with that of the other breast image, and then, the doctor observes both breast image while pushing them against the film viewer so as to fix them at the adjusted positions. As a result, it also becomes possible for the doctor to efficiently conduct the comparing film-image observation.

Incidentally, the preferred embodiment detailed in the foregoing is merely an appropriate example of the breast image processing system 100 embodied in the present invention. Accordingly, the scope of the present invention is not limited to the above.

For instance, although the film size is assumed as the 8×10 inch size in the embodiment detailed in the foregoing, the scope of the present invention is not limited to this size. It is also applicable that plural kinds of films, sizes of which are different from each other, can be loaded into the image recording apparatus 3. In this case, since, sometimes, the film aligning direction at the time of exposure scanning operation would be different for every film size (for instance, as for the film of the 8×10 inch size, the long side of the film is aligned in parallel to the scanning direction, while, as for the film of the 11×14 inch size, the long side of the film is aligned in a direction perpendicular to the scanning direction, etc.), the image processing apparatus 2 acquires the film position information corresponding to the size of the film to be outputted from the image recording apparatus 3, to implements the second format processing.

Further, after the format conversion processing according to the second format processing has been completed, when the image data are transmitted to the image recording apparatus 3, it is applicable to transmit the image data in such a state that the image data represents the image in which the images and the characters are superimposed with each other as shown in FIG. 8, etc. Alternatively, it is also applicable to divide the image data into image part data and character part data, so as to transmit the image part data, the character part data and additional data representing the disposed position information of the characters on the image area to the image recording apparatus 3.

Further, although the information indicating the discrimination between the left and right breast images are allotted onto the images as the stamp information in the aforementioned embodiment, when the breast images have been captured with the lead marker indicating the discrimination between the left and right breast images, it is applicable that, according to the instruction sent from the position confirming screen 231 mentioned in the foregoing, the processing to adjust the position of the lead marker is applied to the image data.

Other than the above, with respect to the detailed structures and the detailed operations of each of the apparatuses constituting the breast image processing system 100, disclosed embodiment can be varied without departing from the spirit and scope of the invention.

1-16. (canceled)

17. A breast image processing system, comprising:
an image data creating apparatus that separately radiographs a left breast and a right breast, both of which belong to the same patient, so as to create left breast image data and right breast image data;
a processing apparatus that is provided with a format processing section to apply a format processing to each of the left breast image data and the right breast image data, both created by the image creating apparatus; and
an image recording apparatus that records and outputs a left breast image and the right breast image onto a recording medium, based on the left breast image data and the right breast image data to each of which the format processing is applied by the processing apparatus;
wherein the format processing section applies the format processing to each of the left breast image data and the right breast image data in such a manner that each of a chest wall portion of the left breast image and another chest wall portion of the right breast image is placed at a position, which has a predetermined relationship with a writing commencement position in the image recording apparatus.

18. The breast image processing system of claim 17,
wherein the processing apparatus is further provided with a position adjusting section that adjusts a position of at least one of the left breast image and the right breast image, when the left breast image and the right breast image are aligned in a left-right direction in such a manner that a chest wall side of the left breast image and another chest wall side of the right breast image match with each other, so that positions of left and right breasts in the left breast image and the right breast image in an upper-lower direction substantially coincide with each other, and then, applies the format processing to each of the left breast image data and the right breast image data.

19. The breast image processing system of claim 17,
wherein the processing apparatus is further provided with an acquiring section to acquire information with respect to an alignment of the recording medium onto which an image is written in the image recording apparatus; and
wherein the format processing section applies the format processing to each of the left breast image data and the right breast image data, based on the information acquired by the acquiring section.

20. The breast image processing system of claim 17, further comprising:
a communication network through which the image data creating apparatus, the processing apparatus and the image recording apparatus are coupled to each other.

21. The breast image processing system of claim 20,
wherein a plurality of image recording apparatuses are coupled to the communication network; and
wherein the acquiring section acquires the information, with respect to the alignment of the recording medium, onto which an image is written in the image recording apparatus, from each of the plurality of image recording apparatuses; and
wherein the format processing section applies the format processing to each of the left breast image data and the right breast image data, based on the acquired information corresponding to the image recording apparatus to be an output destination of each of the left breast image and the right breast image.

22. The breast image processing system of claim 17,
wherein the image recording apparatus is provided with:
a conveyance section to convey the recording medium one by one;
an exposure scanning section to form an image onto the recording medium by conducting an exposure/scanning operation for the recording medium conveyed by the conveyance section; and
a position regulating section to conduct a position regulating operation, so that one side of the recording medium coincides with an exposure/scanning commencement position of the exposure/scanning operation to be conducted by the exposure scanning section; and
wherein the format processing section applies the format processing, so that each of the chest wall portion of the left breast image and the other chest wall portion of the right breast image is placed at one side, the position of which is regulated by the position regulating section.

23. The breast image processing system of claim 17,
wherein the image recording apparatus is provided with:
a conveyance section to convey the recording medium one by one;
an exposure scanning section to form an image onto the recording medium by conducting an exposure/scanning operation for the recording medium conveyed by the conveyance section; and
a write control section to control a write commencement timing when forming an image from a leading edge side in a conveyance direction of the recording medium; and
wherein the format processing section applies the format processing, so that each of the chest wall portion of the left breast image and the other chest wall portion of the right breast image is placed at the leading edge side in the conveyance direction of the recording medium.

24. The breast image processing system of claim 17
wherein the image recording apparatus is provided with:
a conveyance section to convey the recording medium one by one;
an exposure scanning section to form an image onto the recording medium by conducting an exposure/scanning operation for the recording medium conveyed by the conveyance means; and
a write control section to control a write commencement timing when forming an image from a leading edge side in a conveyance direction of the recording medium, so as to create a non-exposure area at a leading edge portion;
wherein the format processing section applies the format processing, so that each of the chest wall portion of the left breast image and the other chest wall portion of the right breast image is placed at a position being apart from the leading edge side by a predetermined distance in the conveyance direction of the recording medium.

25. A breast image processing method to be employed in a breast image processing system including an image data creating apparatus, a processing apparatus and an image recording apparatus, the breast processing method, comprising:
radiographing separately a left breast and the right breast, both of which belong to a same patient, so as to create left breast image data and the right breast image data in the image data creating apparatus;
applying a format processing to each of the left breast image data and the right breast image data, both of which are created by the image data creating apparatus, in the processing apparatus;
recording and outputting a left breast image and a right breast image onto a recording medium, based on the left breast image data and the right breast image data to each of which the format processing is applied by the processing apparatus;
wherein the processing apparatus applies the format processing to each of the left breast image data and the right breast image data in such a manner that each of a chest wall portion of the left breast image and another chest wall portion of the right breast image is placed at a position, which has a predetermined relationship with a writing commencement position in the image recording apparatus.

26. The breast image processing method of claim 25,
wherein the processing apparatus adjusts a position of at least one of the left breast image and the right breast image, when the left breast image and the right breast image are aligned in a left-right direction in such a manner that a chest wall side of the left breast image and another chest wall side of the right breast image match with each other, so that positions of left and right breasts in the left breast image and the right breast image in an upper-lower direction substantially coincide with each other, and then, applies the format processing to each of the left breast image data and the right breast image data.

27. The breast image processing method of claim 25,
wherein the processing apparatus acquires information with respect to an alignment of the recording medium onto which an image is written in the image recording apparatus, and then, applies the format processing to each of the left breast image data and the right breast image data, based on the information acquired.

28. The breast image processing method of claim 25
wherein the breast image processing system further includes: a communication network through which the image data creating apparatus, the processing apparatus and the image recording apparatus are coupled to each other.

29. The breast image processing method of claim 28,
wherein a plurality of image recording apparatuses are coupled to the communication network; and
wherein the processing apparatus acquires the information, with respect to the alignment of the recording medium, onto which an image is written in the image recording apparatus, from each of the plurality of image recording apparatuses, and then, applies the format processing to each of the left breast image data and the right breast image data, based on the acquired information corresponding to the image recording apparatus to be an output destination of each of the left breast image and the right breast image.

30. The breast image processing method of claim 25
wherein the image recording apparatus is provided with:
a conveyance section to convey the recording medium one by one;
an exposure scanning section to form an image onto the recording medium by conducting an exposure/scanning operation for the recording medium conveyed by the conveyance section; and
a position regulating section to conduct a position regulating operation, so that one side of the recording medium coincides with a exposure/scanning commencement position of the exposure/scanning operation to be conducted by the exposure scanning section; and
wherein the processing apparatus applies the format processing, so that each of the chest wall portion of the left breast image and the other chest wall portion of the right breast image is placed at one side, the position of which is regulated by the position regulating means.

31. The breast image processing method of claim 25,
wherein the image recording apparatus is provided with:
a conveyance section to convey the recording medium one by one;
an exposure scanning section to form an image onto the recording medium by conducting an exposure/scanning operation for the recording medium conveyed by the conveyance means; and
a write control section to control a write commencement timing when forming an image from a leading edge side in a conveyance direction of the recording medium; and
wherein the processing apparatus applies the format processing, so that each of the chest wall portion of the left breast image and the other chest wall portion of the right breast image is placed at the leading edge side in the conveyance direction of the recording medium.

32. The breast image processing method of claim 25,
wherein the image recording apparatus is provided with:
a conveyance section to convey the recording medium one by one;
an exposure scanning section to form an image onto the recording medium by conducting an exposure/scanning operation for the recording medium conveyed by the conveyance means; and
a write control section to control a write commencement timing when forming an image from a leading edge side in a conveyance direction of the recording medium, so as to create a non-exposure area at a leading edge portion;
wherein the processing apparatus applies the format processing, so that each of the chest wall portion of the left breast image and the other chest wall portion of the right breast image is placed at a position being apart from the leading edge side by a predetermined distance in the conveyance direction of the recording medium.
